(19) United States
(12) Patent Application Publication
(10) Pub. No.: US 2015/0187287 A1
(43) Pub. Date: Jul. 2, 2015

(54) FIELD SEQUENTIAL DISPLAY APPARATUS AND METHOD

(71) Applicant: Samsung Display Co., Ltd., Yongin-City (KR)

(72) Inventors: Yu-Kwan KIM, Yongin-City (KR); Se-Ah KWON, Yongin-City (KR); Ki-Soo PARK, Yongin-City (KR); Ik-Soo LEE, Yongin-City (KR); Jong-Hak HWANG, Yongin-City (KR)

(73) Assignee: Samsung Display Co., Ltd., Yongin-City (KR)

(21) Appl. No.: 14/290,019

(22) Filed: May 29, 2014

(30) Foreign Application Priority Data
Dec. 30, 2013 (KR) 10-2013-0167494

(51) Int. Cl. G09G 3/34; F21V 33/00

(52) U.S. Cl. CPC G09G 3/3413; F21V 33/0052; G09G 2310/0235; G09G 2320/0261; G09G 2320/0242

(57) ABSTRACT

A field sequential display apparatus includes a backlight including a plurality of light sources which emits light of different colors, and a grayscale representation unit including a plurality of sub-pixels, in which the plurality of light sources includes a first light source which emits light of a first color, the plurality of sub-pixels includes a first type sub-pixel covered with a color filter of a second color, which is different from the first color, and the first type sub-pixel displays a third color, which is different from the first and second colors, using the light emitted from the first light source and passed through the color filter of the second color.

This application claims priority to Korean Patent Application No. 10-2013-0167494, filed on Dec. 30, 2013, and all the benefits accruing therefrom under 35 U.S.C. §119, the content of which in its entirety is herein incorporated by reference.

### BACKGROUND

1. Field

One or more exemplary embodiment of the invention relates to a field sequential display apparatus having a relatively wide color gamut and a field sequential display method for providing a wide color gamut.

2. Description of the Related Art

A method of displaying color images may be classified into a color filter method and a field sequential driving method. The color filter method is a method of displaying a desired color by adjusting the amount of light passing through a color filter formed of three primary colors of red, green and blue. In this case, a single pixel may include three kinds of sub-pixels corresponding to the three primary colors of red, green and blue, respectively.

The field sequential driving method is a method of displaying a desired color by adjusting the amount of light that is emitted from each pixel in synchronization with a lighting cycle after sequentially turning on a plurality of light sources, e.g., red, green and blue light sources. That is, a single pixel sequentially displays three primary color light of red, green and blue, and viewers recognize the displayed three primary color light as a color image due to a visual afterimage effect.

Since the color filter method uses red, green and blue color filters and white light, and the field sequential driving method also uses red, green and blue light sources, a color gamut that may be represented by such a color filter method and a field sequential driving method may be restricted.

### SUMMARY

One or more embodiments of the invention include a field sequential display apparatus having a wide color gamut.

One or more embodiments of the invention include a field sequential display method for providing a wide color gamut.

Additional aspects will be set forth in part in the description which follows and, in part, will be apparent from the description, or may be learned by practice of the exemplary embodiments described herein.

According to one or more exemplary embodiments of the invention, a field sequential display apparatus includes: a backlight including a plurality of light sources which emits light of different colors; and a grayscale representation unit including a plurality of sub-pixels, where the plurality of light sources include a first light source which emits light of a first color, the plurality of sub-pixels include a first type sub-pixel covered with a color filter of a second color, which is different from the first color, and the first type sub-pixel displays a third color, which is different from the first and second colors, using the light emitted from the first light source and passed through the color filter of the second color.

In an exemplary embodiment, a color coordinate point of the third color may be positioned outside a color coordinate triangle obtained by connecting color coordinate points of red, green, and blue which are displayed by the field sequential display apparatus.

In an exemplary embodiment, the first color may be one of green and blue, the second color may be the other of green and blue, and the third color may be a color of a cyan type.

In an exemplary embodiment, the first color may be one of red and green, the second color may be the other of red and green, and the third color may be a color of a yellow type.

In an exemplary embodiment, the plurality of light sources may be turned on or off in a predetermined order in synchronization with a plurality of fields one of a frame.

In an exemplary embodiment, the plurality of light sources may further include a second light source which emits light of the second color and a third light source which emits light of a fourth color, which is different from the first through third colors, the plurality of sub-pixels may further include a second type sub-pixel covered with a color filter of the first color, a third type sub-pixel covered with a color filter of the fourth color, and a fourth type sub-pixel not covered with a color filter, and the plurality of fields may include a first field, in which the first light source is turned on, a second field, in which the second light source is turned on, and a third field, in which the third light source is turned on.

In an exemplary embodiment, the light of the first color emitted from the first light source may pass through the first type sub-pixel, the second type sub-pixel and the fourth type sub-pixel, the light of the second color emitted from the second light source may pass through the first type sub-pixel, the second type sub-pixel and the fourth type sub-pixel, and the light of the fourth color emitted from the third light source may pass through the third type sub-pixel and the fourth type sub-pixel.

In an exemplary embodiment, a color coordinate point of a color that is displayed by light passing through the second type sub-pixel after being emitted from the second light source in the second field may be positioned outside a color coordinate triangle obtained by connecting color coordinate points of red, green, and blue which are displayed by the field sequential display apparatus.

In an exemplary embodiment, the light of the second color emitted from the second light source may pass through the third type sub-pixel, and the light of the fourth color emitted from the third light source may pass through the first type sub-pixel.

In an exemplary embodiment, at least one of a color coordinate point of a color displayed by light passed through the third type sub-pixel after being emitted from the second light source in the second field, and a color coordinate point of a color displayed by light passed through the first type sub-pixel after being emitted from the third light source in the third field, may be positioned outside a color coordinate triangle obtained by connecting color coordinate points of red, green and blue, which are displayed by the field sequential display apparatus.

In an exemplary embodiment, the first color may be blue, the second color may be green, and the fourth color may be red.

In an exemplary embodiment, the plurality of sub-pixels may further include a second type sub-pixel covered with a color filter of a fourth color, which is different from the first through third colors, and a third type sub-pixel not covered with a color filter, the plurality of light sources may further include a second light source which emits light of a fifth color, which is different from the first through fourth colors, and the plurality of fields may include a first field, in which the first light source is turned on, and a second field, in which the second light source is turned on.

In an exemplary embodiment, the light of the first color emitted from the first light source may pass through the first type sub-pixel and the third type sub-pixel, and the light of the fifth color emitted from the second light source may pass through the first type sub-pixel, the second type sub-pixel, and the third type sub-pixel.

In an exemplary embodiment, light passed through the first type sub-pixel after being emitted from the first light source may have the third color and light passed through the third type sub-pixel after being emitted from the first light source may have the first color, light passing through the first type sub-pixel after being emitted from the second light source may have the second color, light passed through the second type sub-pixel after being emitted from the second light source may have the fourth color, and light passed through the third type sub-pixel after being emitted from the second light source may have the fifth color.

In an exemplary embodiment, the first color may be blue, the second color may be green, the third color may be a color of a cyan type, the fourth color may be red, and the fifth color may be a color of a yellow type.

According to one or more exemplary embodiments of the invention, a field sequential display apparatus includes: a backlight including a first light source which emits light of a first color, a second light source which emits light of a second color, and a third light source which emits light of a third color; a grayscale representation unit including a first type sub-pixel covered with a color filter of the first color, a second type sub-pixel covered with a color filter of the second color, a third type sub-pixel covered with a color filter of the third color, and a fourth type sub-pixel not covered with a color filter; and a controller which controls an operation of the backlight and the grayscale representation unit such that the light of the first color, which is emitted from the first light source in a first field of a frame, passes through the first type sub-pixel and the fourth type sub-pixel, the light of the second color, which is emitted from the second light source in a second field of the frame, passes through the second type sub-pixel, the third type sub-pixel and the fourth type sub-pixel, and the light of the third color, which is emitted from the third light source in a third field of the frame, passes through the second type sub-pixel, the third type sub-pixel and the fourth type sub-pixel.

In an exemplary embodiment, a color coordinate point of a color displayed by light passed through the third type sub-pixel after being emitted from the second light source in the second field, and a color coordinate point of a color displayed by light passed through the second type sub-pixel after being emitted from the third light source in the third field may be positioned outside a color coordinate triangle obtained by connecting a first color coordinate point of the first color of the light emitted from the first light source, a second color coordinate point of the second color of the light emitted from the second light source and a third color coordinate point of the third color of the light emitted from the third light source.

In an exemplary embodiment, the first color may be red, the second color may be green, and the third color may be blue.

According to one or more exemplary embodiments of the invention, a field sequential display method may include: allowing light of a first color, which is emitted from a first light source, to pass through a first type sub-pixel covered with a color filter of a second color, which is different from the first color, to display a third color, which is different from the first and second colors, in a first field of a plurality of fields of a frame, where a color coordinate point of the third color is positioned outside a color coordinate triangle obtained by connecting color coordinate points of red, green and blue which are displayed by the field sequential display method.

In an exemplary embodiment, the field sequential display method may further include allowing light of the second color, which is emitted from a second light source, to pass through a second type sub-pixel covered with a color filter of the first color to display a fourth color, which is different from the first and second colors, in a second field of the fields of the frame, where a color coordinate point of the fourth color is positioned outside the color coordinate triangle.

### BRIEF DESCRIPTION OF THE DRAWINGS

These and/or other features of the invention will become apparent and more readily appreciated from the following detailed exemplary embodiments, taken in conjunction with the accompanying drawings, in which:

FIG. 1 is a schematic block diagram of an exemplary embodiment of a field sequential display apparatus according to the invention;

FIG. 2 is a timing diagram illustrating turn-on and turn-off timing of light sources of an exemplary embodiment of a field sequential display apparatus according to the invention;

FIG. 3 is a diagram illustrating colors that are represented by an exemplary embodiment of a field sequential display apparatus in each field, according to the invention;

FIG. 4 is a graph illustrating color coordinate points of colors that are represented by an exemplary embodiment of a field sequential display apparatus, according to the invention;

FIG. 5 is wavelength graphs showing colors represented by an exemplary embodiment of a field sequential display apparatus, according to the invention;

FIG. 6A is a diagram illustrating pixels of an exemplary embodiment of a field sequential display apparatus according to the invention;

FIG. 6B is a diagram illustrating pixels of an alternative exemplary embodiment of a field sequential display apparatus according to the invention;

FIG. 6C is a diagram illustrating pixels of another alternative exemplary embodiment of a field sequential display apparatus according to the invention; and

FIG. 7 is a diagram exemplarily illustrating colors that are represented by an alternative exemplary embodiment of a field sequential display apparatus in each field, according to the invention.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the claims.

Expressions such as “at least one of,” when preceding a list of elements, modify the entire list of elements and do not modify the individual elements of the list.

A field sequential display apparatus displays color images to the outside by using a field sequential driving method. The field sequential driving method is a method of displaying a color image by adjusting the amount of light that is emitted from each pixel in synchronization with a lighting cycle after sequentially turning on a plurality of light sources, e.g., red, green and blue light sources. That is, three primary color light of red, green and blue is sequentially displayed, and viewers recognize the displayed light as a color image due to a visual afterimage effect.

Prerequisites are defined as follows to easily understand descriptions of field sequential display apparatuses according to various embodiments. A minimum period for displaying a color image is referred to as a frame. One frame includes a plurality of fields. A field is a minimum unit for displaying an image of one color. For example, if a red light source, a green light source and a blue light source are sequentially turned on, the red light source is turned on in a first field to display a red image, the green light source is turned on in a second field to display a green image, and the blue light source is turned on in a third field to display a blue image. The red image, the green image and the blue image are sequentially displayed in a frame including the first through third fields, and viewers recognize the displayed images as color images due to a visual afterimage effect.

Examples of the field sequential display apparatuses, according to various embodiments, may include a liquid crystal display (“LCD”), micro electro-mechanical systems (“MEMS”) shutter display, etc. In addition, the field sequential display apparatuses, according to various embodiments, may be included in application apparatuses, such as televisions, monitors, notebooks, tablets, smart phones, projectors, head-mounted displays, etc., for example. To facilitate the understanding of the invention, descriptions provided below are exemplarily focused on an LCD apparatus that operates by using the field sequential driving method. However, the invention is not limited to the LCD apparatus.

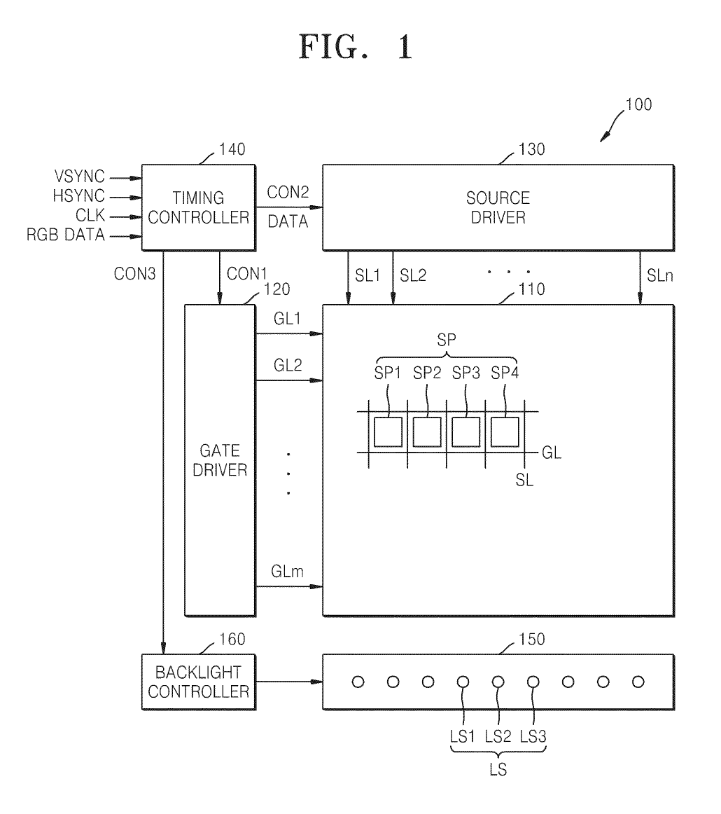

FIG. 1 is a schematic block diagram of an exemplary embodiment of a field sequential display apparatus 100 according to the invention.

Referring to FIG. 1, an exemplary embodiment of the field sequential display apparatus 100 may include a grayscale representation unit 110, a gate driver 120, a source driver 130, a timing controller 140, a backlight 150 and a backlight controller 160. The gate driver 120, the source driver 130 and the timing controller 140 may be provided or formed in separate semiconductor chips, or may be integrated in a single semiconductor chip. The gate driver 120 may be provided or formed on the same substrate together with the grayscale representation unit 110.

A plurality of sub-pixels SP is arranged in the grayscale representation unit 110. The plurality of sub-pixels SP may be classified into various types of sub-pixels. In an exemplary embodiment, as illustrated in FIG. 1, the plurality of sub-pixels SP may include a plurality of first type sub-pixels SP1, a plurality of second type sub-pixels SP2, a plurality of third type sub-pixels SP3, and a plurality of fourth type sub-pixels SP4. In an alternative exemplary embodiment, the plurality of sub-pixels SP may include three types of sub-pixels. The plurality of first type sub-pixels SP1 may be covered with a color filter of a first color, that is, the color filter of a first color is disposed on and overlapping the plurality of first type sub-pixels SP1. The plurality of second type sub-pixels SP2 may be covered with a color filter of a second color. The plurality of third type sub-pixels SP3 may be covered with a color filter of a third color. The plurality of fourth type sub-pixels SP4 may not be covered with a color filter, and light of all colors may pass through the plurality of fourth type sub-pixels SP4. A predetermined number of sub-pixels SP may define or form a single pixel. In an exemplary embodiment, each pixel may include a first type sub-pixel SP1, a second type sub-pixel SP2, a third type sub-pixel SP3 and a fourth type sub-pixel SP4

Herein, a first color, a second color and a third color are different colors from each other. In one exemplary embodiment, for example, the first color may be red, the second color may be green, and the third color may be blue. Hereinafter, for convenience of description, exemplary embodiments where the first color is red, the second color is green and the third color is blue will be described, but first through fifth colors are not limited thereto.

A plurality of gate lines GL1 through GLm extending in a first direction (e.g., a row direction) and a plurality of source lines SL1 through SLn extending in a second direction (e.g., a column direction) are disposed or arranged in the grayscale representation unit 110 (where m and n are natural numbers that are greater than “1”). The plurality of gate lines GL1 through GLm and the plurality of source lines SL1 through SLn are electrically connected to the plurality of sub-pixels SP.

A data signal that is transmitted through a source line is input to a sub-pixel SP corrected thereto in response to a scan signal that is transmitted through a gate line connected to the sub-pixel SP, and the sub-pixel SP may represent or display a grayscale corresponding to the data signal. In one exemplary embodiment, for example, the sub-pixel SP may include a liquid crystal layer that is interposed between a pixel electrode and an opposite electrode thereof, and may represent a grayscale by applying a voltage corresponding to the data signal between the pixel electrode and the opposite electrode. In such an embodiment, the grayscale representation unit 110 may be a liquid crystal panel.

The backlight 150 includes a plurality of light sources LS that emits light of different colors. In an exemplary embodiment, as illustrated in FIG. 1, the plurality of light sources LS may include a first light source LS1 that emits light of a first color, a second light source LS2 that emits light of a second color, and a third light source LS3 that emits light of a third color. However, the invention is not limited thereto. In an alternative exemplary embodiment, the plurality of light sources LS may include two types of light sources that emits light of different colors, and when the two kinds of light sources simultaneously emit light, white light may be emitted. In one exemplary embodiment, for example, the plurality of light sources LS may include a light source that emits yellow light and a light source that emits blue light. According to another exemplary embodiment, the plurality of light sources LS may include a light source that emits red light and a light source that emits cyan light. According to another exemplary embodiment, the plurality of light sources LS may include a light source that emits green light and a light source that emits magenta light.

The first light source LS1, the second light source LS2 and the third light source LS3 may be turned on or off sequentially in a predetermined order in synchronization with fields in a frame.

The timing controller 140 may control the gate driver 120, the source driver 130 and the backlight controller 160. The timing controller 140 may receive a vertical sync signal VSYNC for an input frame, a horizontal sync signal HSYNC for the input frame, a clock signal CLK and input image data RGB DATA, and may generate a plurality of control signals including a first control signal CON1, a second control signal CON2 and a third control signal CON3. In an exemplary embodiment, the timing controller 140 may generate the first control signal CON1, the second control signal CON2, the third control signal CON3 and digital image data DATA, based on the horizontal sync signal HSYNC and the vertical sync signal VSYNC.

The gate driver 120 may sequentially drive the plurality of gate lines GL1 through GLm in response to the first control signal CON1. In an exemplary embodiment, the first control signal CON1 may be a signal that directs the gate driver 120 to scan the plurality of gate lines GL1 through GLm. The gate driver 120 may generate a scan signal, and may sequentially provide the scan signal to the sub-pixels SP through the gate lines GL1 through GLm.

The source driver 130 may drive the plurality of source lines SL1 through SLn in response to the second control signal CON2 and the digital image data DATA. The source driver 130 may convert the digital image data DATA having a grayscale information into data signals having a grayscale voltage corresponding to the grayscale information, and may sequentially provide the data signals to the sub-pixels SP through the source lines SL1 through SLn.

The backlight controller 160 may drive the first through third light sources LS1 through LS3 sequentially in a predetermined order in response to the third control signal CON3. In one exemplary embodiment, for example, the backlight controller 160 may control the first through third light sources LS1 through LS3 so that the first light source LS1 is turned on in a first field, the second light source LS2 is turned on in a second field, and the third light source LS3 is turned on in a third field.

Herein, the timing controller 140, the gate driver 120, the source river 130 and the backlight controller 160 may be collectively referred to as a controller.

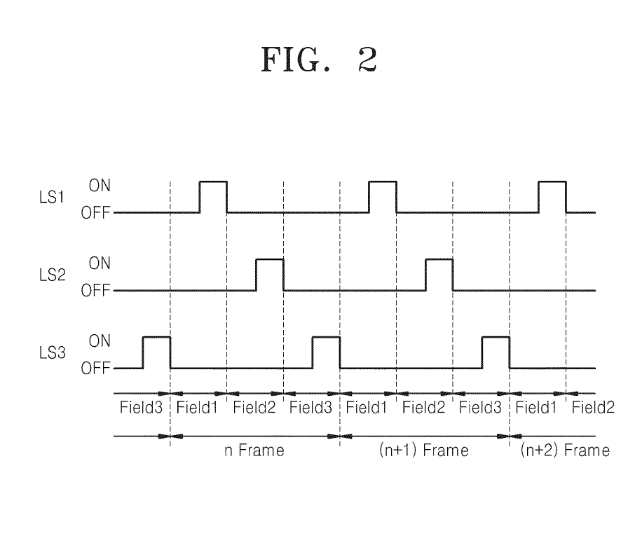

FIG. 2 is a timing diagram illustrating turn-on and turn-off timing of light sources of an exemplary embodiment of a field sequential display apparatus according to the invention.

Referring to FIG. 2, in an exemplary embodiment, one frame includes first through third fields Field1 through Field3. A first light source LS1 that emits light of a first color is turned on in the first field Field1 of a current frame, e.g., an n-th frame n Frame, a second light source LS2 that emits light of a second color is turned on in the second field Field2 of the current frame n Frame, and a third light source LS3 that emits light of a third color is turned on in the third field Field3 of the current frame n Frame. Also in a next frame, e.g., an (n+1)-th Frame (n−1) Frame, the first through third light sources LS1 through LS3 are sequentially turned on in synchronization with the first through third fields Field1 through Field3 in the same manner as in the current frame n Frame.

Hereinafter, a process, in which images of the current frame n Frame are represented, will be described according to a time sequence. In an exemplary embodiment, digital image data DATA of the current frame n Frame includes first through third data.

When the first field Field1 starts, the first data of the current frame n Frame is written in the grayscale representation unit 110, and the sub-pixels SP of the grayscale representation unit 110 represent a grayscale corresponding to the first data. When the grayscale representation unit 110 is in a state for representing the grayscale corresponding to the first data, the backlight controller 150 turns on the first light source LS1, and thus, a first image corresponding to the first data is represented. The first image substantially has the first color. When the first light source LS1 is turned off, the first field Field1 ends.

When the second field Field2 starts, the second data of the current frame n Frame is written in the grayscale representation unit 110, and the sub-pixels SP of the grayscale representation unit 110 represent a grayscale corresponding to the second data. When the grayscale representation unit 110 is in a state for representing the grayscale corresponding to the second data, the backlight controller 150 turns on the second light source LS2, and thus, a second image corresponding to the second data is represented. The second image substantially has the second color. When the second light source LS2 is turned off, the second field Field2 ends.

When the third field Field3 starts, the third data of the current frame n Frame is written in the grayscale representation unit 110, and the sub-pixels SP of the grayscale representation unit 110 represent a grayscale corresponding to the third data. When the grayscale representation unit 110 is in a state for representing the grayscale corresponding to the third data, the backlight controller 150 turns on the third light source LS3, and thus, a third image corresponding to the third data is represented. The third image mainly has the third color. When the third light source LS3 is turned off, the third field Field3 ends. Subsequently, an image of the next frame (n−1) Frame and an image of the next frame of the next frame (n+1) Frame, e.g., an (n+2)-th frame (n+2) Frame, are sequentially represented.

Since the first through third images are sequentially represented at high speed, a viewer recognizes color images corresponding to the digital image data DATA due to a visual afterimage effect.

In one exemplary embodiment, for example, as shown in the timing diagram of FIG. 2, the third light source LS3 may be turned on in the first field Field1, the second light source LS2 may be turned on in the second field Field2, and the third light source LS3 may be turned on in the third field Field3, but not being limited thereto. According to an alternative exemplary embodiment, the second light source LS2 and the third light source LS3 may be simultaneously turned on in the first field Field1, the first light source LS1 may be turned on in the second field Field2, and the first through third light sources LS1 through LS3 may be simultaneously turned on in the third field Field3.

According to another exemplary embodiment, one frame may include two fields. In one exemplary embodiment, for example, the first light source LS1 and the second light source LS2 may be simultaneously turned on in the first field Field1, and the third light source LS3 may be turned on in the second field Field2.

According to another alternative exemplary embodiment, one frame may include four or more fields. In one exemplary embodiment, for example, the first light source LS1 may be turned on in the first field Field1, the second light source LS2 may be turned on in the second field Field2, the third light source LS3 may be turned on in the third field Field3, and the first through third light sources LS1 through LS3 may be simultaneously turned on in a fourth field. According to another alternative exemplary embodiment, the first light source LS1 may be turned on in the first field Field1, the second light source LS2 may be turned on in the second field Field2, the third light source LS3 may be turned on in the third field Field3, and the second light source LS2 may be turned on in a fourth field.

According to another alternative exemplary embodiment, the first light source LS1 may be turned on in the first field Field1, the second light source LS2 may be turned on in the second field Field2, the third light source LS3 may be turned on in the third field Field3, and a color of an additional color gamut may be represented in at least one next field (e.g., a fourth field, or a fourth field and a fifth field). The additional color gamut means a color gamut that is positioned outside a color coordinate triangle obtained by connecting color coordinate points of red, green and blue which are displayed by the field sequential display apparatus 100 in color coordinates. A color gamut that is positioned inside the color coordinate triangle in the color coordinates is referred to as a basic color gamut. In the exemplary embodiment of FIG. 1, the color coordinate triangle may be defined as a triangle obtained by connecting, in the color coordinates, a first color coordinate point of the first color of light emitted from the first light source LS1, a second color coordinate point of the second color of light emitted from the second light source LS2, and a third color coordinate point of the third color of light emitted from the third light source LS3. That is, colors of the basic color gamut may be represented in the first through third fields Field1 through Field3, and colors of the additional color gamut may be represented in at least one next field.

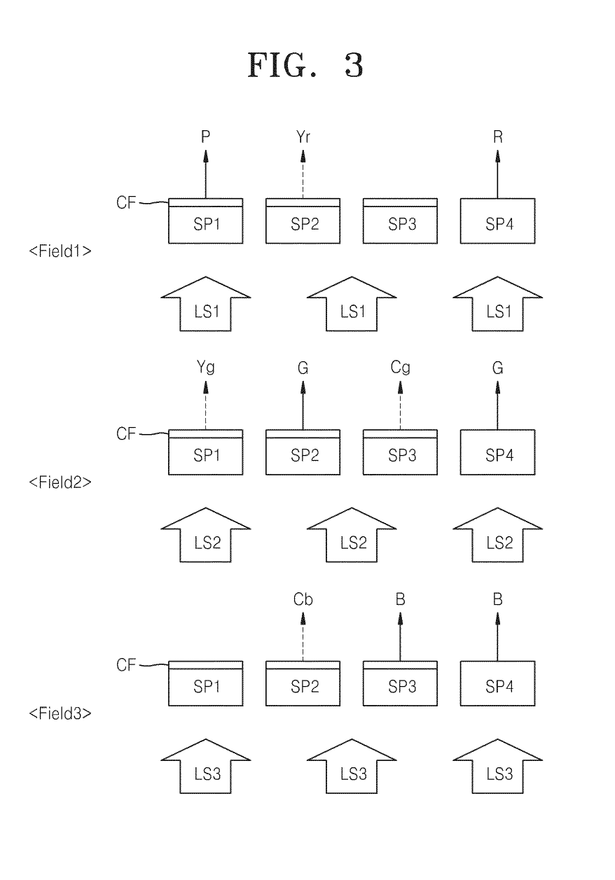

FIG. 3 is a diagram illustrating colors that are represented by an exemplary embodiment of a field sequential display apparatus in each field, according to the invention.

Referring to FIG. 3, by using light of a third color, which is emitted from a third light source LS3 in a third field Field3 and passed through a second type sub-pixel SP2 covered with a color filter CF of a second color, the second type sub-pixel SP2 displays a color Cb that is different from the third color and the second color. The color Cb displayed by the second type sub-pixel SP2 may be a color of a cyan type, e.g., a cyanish color, and a color coordinate point of the color Cb displayed by the second type sub-pixel SP2 may be outside the basic color gamut, that is, may be included within the additional color gamut. Herein, the color of a cyan type means a color that is cyanish or substantially close to cyan.

According to another exemplary embodiment, by using light of the second color, which is emitted from a second light source LS2 in a second field Field2 and passed through a third type sub-pixel SP3 covered with a color filter CF of the third color, the third type sub-pixel SP3 may display a color Cg that is different from the second color and the third color. The color Cg displayed by the third type sub-pixel SP3 is a color of a cyan type, and a color coordinate point of the color Cg displayed by the third type sub-pixel SP3 may be outside the basic color gamut, that is, may be included within the additional color gamut.

According to another exemplary embodiment, by using light of the second color, which is emitted from the second light source LS2 in the second field Field2 and passed through a first type sub-pixel SP1 covered with a color filter CF of a first color, the first type sub-pixel SP1 may display a color Yg that is different from the second color and the first color. The color Yg displayed by the first type sub-pixel SP1 is a color of a yellow type, e.g., a yellowish color, and a color coordinate point of the color Yg displayed by the first type sub-pixel SP1 may be outside the basic color gamut, that is, may be included within the additional color gamut. Herein, a color of a yellow type means a color, which is yellowish or substantially close to yellow.

According to another exemplary embodiment, by using light of the first color, which is emitted from a first light source LS1 in a first field Field1 and passed through the second type sub-pixel SP2 covered with a color filter CF of the second color, the second type sub-pixel SP2 may display a color Yr that is different from the first color and the second color. The color Yr displayed by the second type sub-pixel SP2 is a color of a yellow type, and a color coordinate point of the color Yr may be outside the basic color gamut, that is, may be included within the additional color gamut.

As described above, in an exemplary embodiment where the first color is red, the second color is green, and the third color is blue, the first, second and third light sources LS1, LS2, and LS3 emit red light, green light and blue light, respectively. In such an embodiment, the first, second and third type sub-pixels SP1, SP2 and SP3 are covered with a red color filter, a green color filter and a blue color filter, respectively.

In an exemplary embodiment, as shown in FIG. 3, the first light source LS1 that emits red light is turned on in the first field Field1. The first, second and fourth type sub-pixels SP1, SP2 and SP4 of the grayscale representation unit 110 may be activated, and the third type sub-pixel SP3 of the grayscale representation unit 110 may be deactivated. The first type sub-pixel SP1 and the fourth type sub-pixel SP4 may represent red R, the second type sub-pixel SP2 may represent the color Yr of the yellow type which is different from red R and green G, and the third type sub-pixel SP3 may not represent any color. The field sequential display apparatus 100 may display a red image, an image of the color Yr of the yellow type, or an image in which red R and the color Yr of the yellow type are combined.

According to another exemplary embodiment, the second type sub-pixel SP2 may be deactivated in the first field Field1. In such an embodiment, the field sequential display apparatus 100 displays a red image in the first field Field1.

In an exemplary embodiment, as shown in FIG. 3, the second light source LS2 that emits green light is turned on in the second field Field2. The first through fourth type sub-pixels SP1, SP2, SP3 and SP4 of the grayscale representation unit 110 may be activated. The first type sub-pixel SP1 may represent the color Yg of a yellow type, which is different from green G and red R, the second type sub-pixel SP2 and the fourth type sub-pixel SP4 may represent green G, and the third type sub-pixel SP3 may represent the color Cg of the cyan type, which is different from green G and blue B. The field sequential display apparatus 100 may display a green image, an image of the color Yg of the yellow type, an image of the color Cg of the cyan type, or an image in which at least two colors of green G, the color Yg of the yellow type, and the color Cg of the cyan type are combined.

According to another exemplary embodiment, the first type sub-pixel SP1 may be deactivated in the second field Field2. In such an embodiment, the field sequential display apparatus 100 may not represent the color Yg of the yellow type in the second field Field2.

According to another exemplary embodiment, the third type sub-pixel SP3 may be deactivated in the second field Field2. In such an embodiment, the field sequential display apparatus 100 may not represent the color Cg of the cyan type in the second field Field2.

According to another exemplary embodiment, the first type sub-pixel SP1 and the third type sub-pixel SP3 may be deactivated in the second field Field2. In such an embodiment, in the second field Field2, the field sequential display apparatus 100 may not represent the color Yg of the yellow type and the color Cg of the cyan type, and may represent only a green image.

In an exemplary embodiment, as shown in FIG. 3, the third light source LS3 that emits blue light is turned on in the third field Field3. The second, third and fourth type sub-pixels SP2, SP3, and SP4 of the grayscale representation unit 110 may be activated, and the first type sub-pixel SP1 of the grayscale representation unit 110 may be deactivated. The first type sub-pixel SP1 may not represent any color, the second type sub-pixel SP2 may represent the color Cb of the cyan type, which is different from green G and blue B, and the third type sub-pixel SP3 and the fourth type sub-pixel SP4 may represent blue B. The field sequential display apparatus 100 may display a blue image, an image of the color Cb of the cyan type, or an image in which blue B and the color Cb of the cyan type are combined.

According to another exemplary embodiment, the second type sub-pixel SP2 may be deactivated in the third field Field3. In such an embodiment, the field sequential display apparatus 100 displays the blue image in the third field Field3.

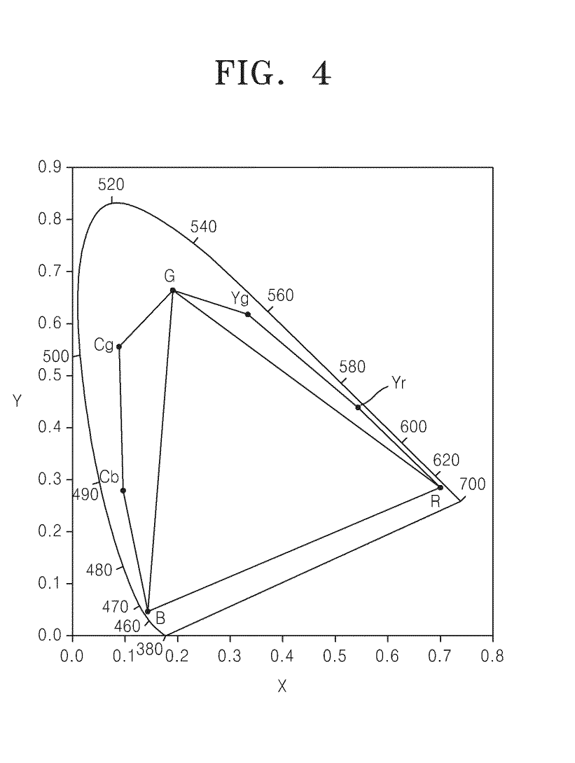

FIG. 4 is a graph illustrating color coordinate points of colors that are represented by an exemplary embodiment of the field sequential display apparatus 100, according to the invention.

Referring to FIG. 4, a standard color coordinate system that was established by the international commission on illumination (CIE) in 1931 is illustrated schematically. The standard color coordinate system is referred to as a CIE 1931 XYZ color space, and is one of color spaces mathematically defined based on research on human color recognition. A curve-shaped boundary of the color space corresponds to short wavelength light, and a wavelength of the short wavelength light is expressed in nanometers. A straight line boundary below the color space corresponds to a color that may not be represented by the short wavelength light.

Color coordinate points of red, green and blue, which may be represented by an exemplary embodiment of the field sequential display apparatus 100, are shown in FIG. 4. In FIG. 4, a color coordinate triangle having a red color coordinate point R, a green color coordinate point G and a blue color coordinate point B is illustrated as three vertexes. A color gamut inside the coordinate triangle is a range of colors that may represented by the field sequential display apparatus 100 in the case where light emitted from the first light source LS1 in the first field Field1 passes through the first and fourth type sub-pixels SP1 and SP4, light emitted from the second light source LS2 in the second field Field2 passes through the second and fourth type sub-pixels SP2 and SP4, and light emitted from the third light source LS3 in the third field Field3 passes through the third and fourth type sub-pixels SP3 and SP4.

Color coordinate points of the color Cg of the cyan type, the color Cb of the cyan type, the color Yg of the yellow type, and the color Yr of the yellow type, which may be represented by an exemplary embodiment of the field sequential display apparatus 100, are shown in FIG. 4. As illustrated in FIG. 4, the color coordinate point of the color Cg of the cyan type (also referred to as “a first cyanish color”), the color coordinate point of the color Cb of the cyan type (also referred to as “a second cyanish color”), the color coordinate point of the color Yg of the yellow type (also referred to as “a first yellowish color”), and the color coordinate point of the color Yr of the yellow type (also referred to as “a second yellowish color”) are positioned outside of the color coordinate triangle.

A color gamut inside a tetragon that is obtained by connecting the green color coordinate point G, the color coordinate point of the first cyanish color Cg, the color coordinate point of the second cyanish color Cb, and the blue color coordinate point B is a range of colors that may be additionally represented by the field sequential display apparatus 100 by the light that is emitted from the second light source LS2 in the second field Field2 and passed through the third type sub-pixel SP3, and the light that is emitted from the third light source LS3 in the third field Field3 and passed through the second type sub-pixel SP2.

A color gamut inside a tetragon that is obtained by connecting the green color coordinate point G, the color coordinate point of the first yellowish color Yg, the color coordinate point of the second yellowish color Yr, and the color coordinate point R is a range of colors that may be additionally represented by the field sequential display apparatus 100 by the light that is emitted from the first light source LS1 in the first field Field1 and passed through the second type sub-pixel SP2, and the light that is emitted from the second light source LS2 in the second field Field2 and passed through the first type sub-pixel SP1.

In an exemplary embodiment, the field sequential display apparatus 100 may represent colors of a wider color gamut than a conventional display apparatus of the related art that may represent only the colors inside the color coordinate triangle. In an exemplary embodiment, as shown in FIG. 4, the field sequential display apparatus 100 may represent colors of an additional color gamut in addition to colors of a basic color gamut inside the color coordinate triangle. In one exemplary embodiment, for example, when the input data RGB DATA includes a color outside the color coordinate triangle, the conventional display apparatus of the related art may not represent the color outside the color coordinate triangle, and thus represent a color by using only a color inside the color coordinate triangle, such that color distortion may occur therein. According to an exemplary embodiment of the invention, the field sequential display apparatus 100 has a relatively wide color gamut, and thus may reproduce colors of the input image data without any change.

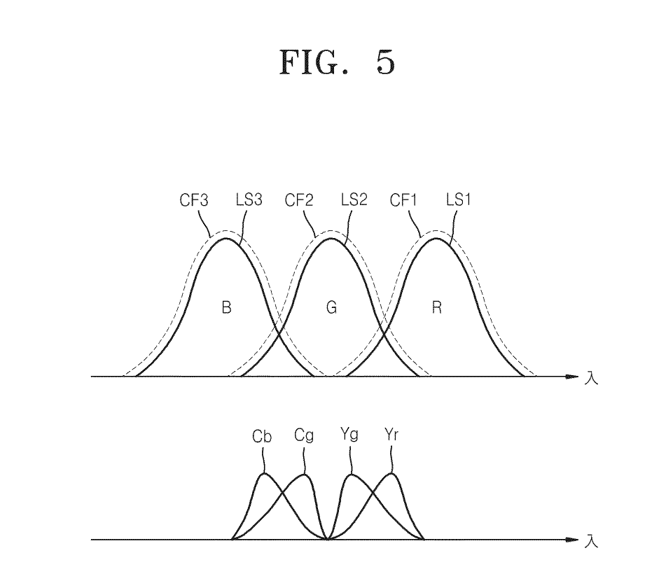

FIG. 5 is wavelength graphs illustrating colors represented by an exemplary embodiment of the field sequential display apparatus 100, according to the invention.

A graph of the intensity for wavelengths of red light R, green light G and blue light B is schematically illustrated in FIG. 5. In an exemplary embodiment, the red light R is emitted from the first light source LS1, the green light G is emitted from the second light source LS2, and the blue light B is emitted from the third light source LS3. In addition, a graph of the transmittance for wavelengths of a red color filter CF1, a green color filter CF2 and a blue color filter CF3 is roughly illustrated in FIG. 5. The red color filter CF1 covers the first type sub-pixel SP1, the green color filter CF2 covers the second type sub-pixel SP2, and the blue color filter CF3 covers the third type sub-pixel SP3.

In such an embodiment, when the blue light B emitted from the third light source LS3 passes through the green color filter CF2, the color Cb of the cyan type is represented. When the blue light B and the green light G are mixed, a color similar to the color Cb of the cyan type may be generated. However, since the color similar to the color Cb of the cyan type is generated by a mixture of lights of a relatively wide wavelength band obtained by adding a wavelength band of the blue light B and a wavelength band of the green light G, the color similar to the color Cb of the cyan type is positioned inside the color coordinate triangle. As shown in the lower graph of FIG. 5, light that is represented by the color Cb of the cyan type has a relatively small wavelength band, and thus is close to short wavelength light and is positioned outside the color coordinate triangle.

When the green light G emitted from the second light source LS2 passes through the blue color filter CF3, the color Cg of the cyan type is represented. When the green light G and the blue light B are mixed, a color similar to the color Cg of the cyan type may be generated. However, since the color similar to the color Cg is generated by a mixture of lights of a relatively wide wavelength band obtained by adding a wavelength band of the green light G and a wavelength band of the blue light B, the color similar to the color Cg is positioned inside the color coordinate triangle. As shown in the lower graph of FIG. 5, light that is represented by the color Cg of the cyan type has a relatively small wavelength band, and thus is close to short wavelength light and is positioned outside the color coordinate triangle.

When the green light G emitted from the second light source LS2 passes through the red color filter CF1, the color Yg of the yellow type is represented. When the green light G and the red light R are mixed, a color similar to the color Yg of the yellow type may be generated. However, since the color similar to the color Yg is generated by a mixture of lights of a relatively wide wavelength band obtained by adding a wavelength band of the green light G and a wavelength band of the red light R, the color similar to the color Yg is positioned inside the color coordinate triangle. As shown in the lower graph of FIG. 5, light that is represented by the color Yg has a relatively small wavelength band, and thus is close to short wavelength light and is positioned outside the color coordinate triangle.

When the red light R emitted from the first light source LS1 passes through the green color filter CF2, the color Yr of the yellow type is represented. When the red light R and the green light G are mixed, a color similar to the color Yr of the yellow type may be generated. However, since the color similar to the color Yr is generated by a mixture of lights of a relatively wide wavelength band obtained by adding a wavelength band of the red light R and a wavelength band of the green light G, the color similar to the color Yr is positioned inside the color coordinate triangle. As shown in the lower graph of FIG. 5, light that is represented by the color Yr has a relatively small wavelength band, and thus is close to short wavelength light and is positioned outside the color coordinate triangle.

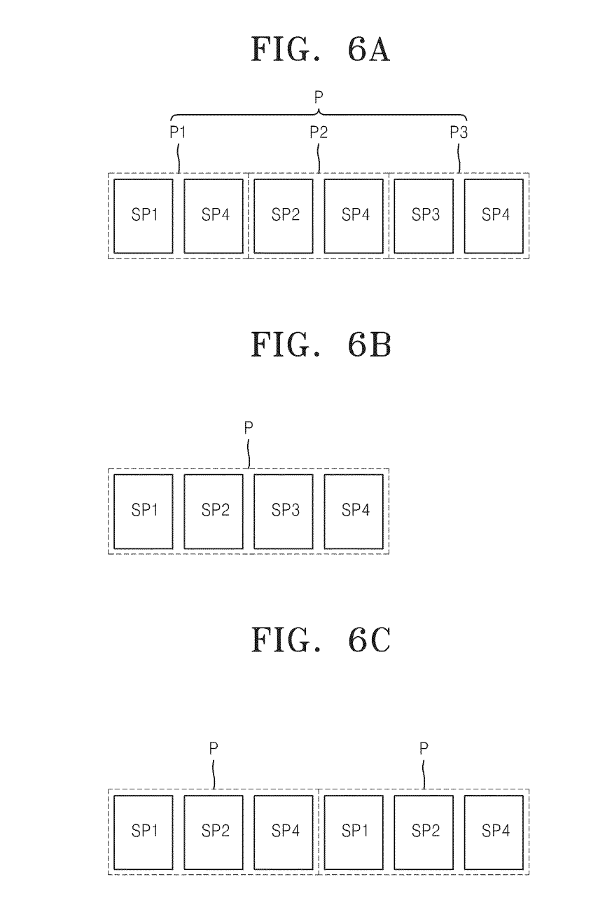

FIG. 6A is a diagram illustrating pixels of an exemplary embodiment of a field sequential display apparatus according to the invention.

Referring to FIG. 6A, the field sequential display apparatus includes pixels P. The pixels P include a first pixel P1, a second pixel P2, and a third pixel P3. The first through third pixels P1, P2 and P3 are disposed to be adjacent to one another. As illustrated in FIG. 6A, the first through third pixels P1, P2 and P3 may be sequentially arranged in a transverse direction.

The first pixel P1 includes a first type sub-pixel SP1 and a fourth type sub-pixel SP4. The first pixel P1 may represent the color Yg of the yellow type (e.g., the first yellowish color) in addition to red, green and blue. The second pixel P2 includes a second type sub-pixel SP2 and a fourth type sub-pixel SP4. The second pixel P2 may represent at least one of the color Yr of the yellow type (e.g., the second yellowish color) and the color Cb of the cyan type (e.g., the first cyanish color), in addition to red, green and blue. The third pixel P3 includes a third type sub-pixel SP3 and a fourth type sub-pixel SP4. The third pixel P3 may represent the color Cg of the cyan type (e.g., the second cyanish color) in addition to red, green and blue.

FIG. 6B is a diagram illustrating pixels of an alternative exemplary embodiment of a field sequential display apparatus according to the invention.

Referring to FIG. 6B, the field sequential display apparatus includes a pixel P. The pixel P includes first through fourth type sub-pixels SP1 through SP4. The pixel P may represent at least one of the color Yg of the yellow type (e.g., the first yellowish color), the color Yr of the yellow type (the second yellowish color), the color Cb of the cyan type (the first cyanish color), and the color Cg of the cyan type (the second cyanish color), in addition to red, green and blue.

FIG. 6C is a diagram illustrating pixels of another alternative exemplary embodiment of a field sequential display apparatus according to the invention.

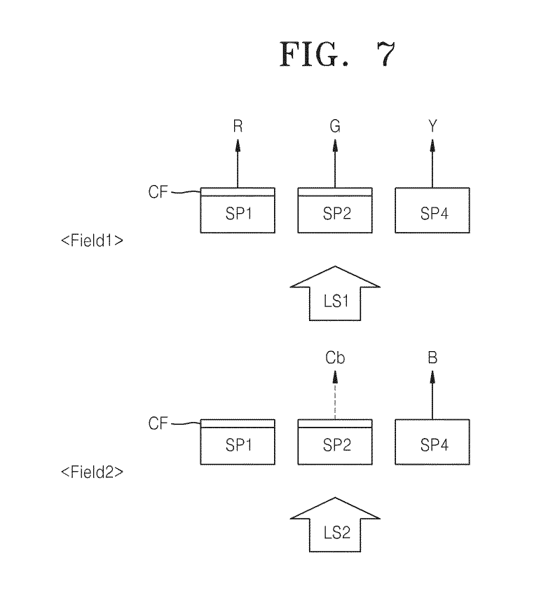

Referring to FIG. 6C, the field sequential display apparatus includes pixels P. Each of the pixels P includes first, second and fourth type sub-pixels SP1, SP2 and SP4. The field sequential display apparatus including the pixels P of FIG. 6C may include a backlight (e.g., the backlight 150 of FIG. 1) including two types of light sources, and one frame may include two fields. This structure of such an embodiment will be described in detail with reference to FIG. 7.

FIG. 7 is a diagram exemplarily illustrating colors that are represented by an exemplary embodiment of a field sequential display apparatus in each field, according to the invention.

Referring to FIG. 7, a backlight (e.g., the backlight 150 of FIG. 1) includes a first light source LS1 that emits yellow light and a second light source LS2 that emits blue light. The first light source LS1 is turned on in a first field Field1, and the second light source LS2 is turned on in a second field Field2.

By the blue light that is emitted from the second light source LS2 in the second field Field2 and passed through a second type sub-pixel SP2 covered with a green color filter CF, the second type sub-pixel SP2 displays a color Cb of the cyan type, which is different from blue and green. Color coordinate point of the color Cb of the cyan type may be outside the basic color gamut, that is, may be included within the additional color gamut.

The first light source LS1 that emits yellow light is turned on in the first field Field1. In an alternative exemplary embodiment, a light source that emits red light and a light source that emits green light may be simultaneously turned on in the first field Field1. A first type sub-pixel SP1 covered with a red color filter CF, the second type sub-pixel SP2 covered with a green color filter CF, and a fourth type sub-pixel SP4 not covered with a color filter may be activated in the first field Field1. The first type sub-pixel SP1 represents red R, the second type sub-pixel SP2 represents green G, and the fourth type sub-pixel SP4 represents yellow Y. In an exemplary embodiment, as shown in FIG. 7, the field sequential display apparatus may display a red image, a green image, a yellow image, or an image, in which at least two colors of red, green, and yellow are combined, in the first field Field1.

The second light source LS2 that emits blue light is turned on in the second field Field2. The first type sub-pixel SP1 may be deactivated, and the second type sub-pixel SP2 and the fourth type sub-pixel SP4 may be activated in the second field Field2. The first type sub-pixel SP1 does not represent any color, the second type sub-pixel SP2 represents a color Cb of the cyan type, and the fourth type sub-pixel SP4 represents blue B. In such an embodiment, the field sequential display may display a blue image, an image of the color Cb of the cyan type, or an image, in which blue B and the color Cb of the cyan type are combined, in the second field Field2.

In such an embodiment, the Cb of the cyan type is positioned outside the color coordinate triangle in the color coordinates, and the field sequential display may represent colors of a relatively wide color gamut.

It should be understood that the exemplary embodiments described herein should be considered in a descriptive sense only and not for purposes of limitation. Descriptions of features or aspects within each embodiment should typically be considered as available for other similar features or aspects in other embodiments.

While one or more embodiments of the invention have been described with reference to the figures, it will be understood by those of ordinary skill in the art that various changes in form and details may be made therein without departing from the spirit and scope of the invention as defined by the following claims.

What is claimed is:

1. A field sequential display apparatus comprising:
a backlight comprising a plurality of light sources which emits light of different colors; and
a grayscale representation unit comprising a plurality of sub-pixels,
wherein
the light plurality of sources comprises a first light source which emits light of a first color,
the plurality of sub-pixels comprises a first type sub-pixel covered with a color filter of a second color, which is different from the first color, and
the first type sub-pixel displays a third color, which is different from the first and second colors, using the light emitted from the first light source and passed through the color filter of the second color.

2. The field sequential display apparatus of claim 1, wherein
a color coordinate point of the third color is positioned outside a color coordinate triangle obtained by connecting color coordinate points of red, green and blue, which are displayed by the field sequential display apparatus.

3. The field sequential display apparatus of claim 1, wherein
the first color is one of green and blue,
the second color is the other of green and blue, and
the third color is a color of a cyan type.

4. The field sequential display apparatus of claim 1, wherein
the first color is one of red and green,
the second color is the other of red and green, and
the third color is a color of a yellow type.

5. The field sequential display apparatus of claim 1, wherein
the plurality of light sources are turned on or off in a predetermined order in synchronization with a plurality of fields of a frame.

6. The field sequential display apparatus of claim 5, wherein
the plurality of light sources further comprises:
a second light source which emits light of the second color; and
a third light source which emits light of a fourth color, which is different from the first through third colors,
the plurality of sub-pixels further comprises:
a second type sub-pixel covered with a color filter of the first color;
a third type sub-pixel covered with a color filter of the fourth color; and
a fourth type sub-pixel not covered with a color filter, and
each of the plurality of fields comprises:
a first field, in which the first light source is turned on;
a second field, in which the second light source is turned on; and
a third field, in which the third light source is turned on.

7. The field sequential display apparatus of claim 6, wherein
the light of the first color emitted from the first light source passes through the first type sub-pixel, the second type sub-pixel and the fourth type sub-pixel,
the light of the second color emitted from the second light source passes through the first type sub-pixel, the second type sub-pixel and the fourth type sub-pixel, and
the light of the fourth color emitted from the third light source passes through the third type sub-pixel and the fourth type sub-pixel.

8. The field sequential display apparatus of claim 7, wherein
a color coordinate point of a color displayed using light passed through the second type sub-pixel after being emitted from the second light source in the second field is positioned outside a color coordinate triangle obtained by connecting color coordinate points of red, green and blue, which are displayed by the field sequential display apparatus.

9. The field sequential display apparatus of claim 7, wherein
the light of the second color emitted from the second light source passes through the third type sub-pixel, and
the light of the fourth color emitted from the third light source passes through the first type sub-pixel.

10. The field sequential display apparatus of claim 9, wherein
at least one of a color coordinate point of a color displayed by light passed through the third type sub-pixel after being emitted from the second light source in the second field, and a color coordinate point of a color displayed by light passing through the first type sub-pixel after being emitted from the third light source in the third field, is positioned outside a color coordinate triangle obtained by connecting color coordinate points of red, green and blue, which are displayed by the field sequential display apparatus.

11. The field sequential display apparatus of claim 9, wherein
the first color is blue,
the second color is green, and
the fourth color is red.

12. The field sequential display apparatus of claim 5, wherein
the plurality of sub-pixels further comprises:
a second type sub-pixel covered with a color filter of a fourth color, which is different from the first through third colors; and
a third type sub-pixel not covered with a color filter,
the plurality of light sources further comprise a second light source which emits light of a fifth color, which is different from the first through fourth colors, and
the plurality of fields comprises:
a first field, in which the first light source is turned on; and
a second field, in which the second light source is turned on.

13. The field sequential display apparatus of claim 12, wherein
in the first field, the light of the first color emitted from the first light source passes through the first type sub-pixel and the third type sub-pixel, and
in the second field, the light of the fifth color emitted from the second light source passes through the first type sub-pixel, the second type sub-pixel and the third type sub-pixel.

14. The field sequential display apparatus of claim 13, wherein
light passed through the first type sub-pixel after being emitted from the first light source has the third color,
light passed through the third type sub-pixel after being emitted from the first light source has the first color, and
light passed through the first type sub-pixel after being emitted from the second light source has the second color,
light passed through the second type sub-pixel after being emitted from the second light source has the fourth color, and
light passed through the third type sub-pixel after being emitted from the second light source has the fifth color.

15. The field sequential display apparatus of claim 13, wherein
the first color is blue,
the second color is green,
the third color is a color of a cyan type,
the fourth color is red, and
the fifth color is a color of a yellow type.

16. A field sequential display apparatus comprising:
a backlight comprising:
a first light source which emits light of a first color;
a second light source which emits light of a second color; and
a third light source which emits light of a third color;
a grayscale representation unit comprising:
a first type sub-pixel covered with a color filter of the first color;
a second type sub-pixel covered with a color filter of the second color;
a third type sub-pixel covered with a color filter of the third color; and
a fourth type sub-pixel not covered with a color filter; and
a controller which controls an operation of the backlight and the grayscale representation unit such that
the light of the first color, which is emitted from the first light source in a first field of a frame, passes through the first type sub-pixel and the fourth type sub-pixel,
the light of the second color, which is emitted from the second light source in a second field of the frame, passes through the second type sub-pixel, the third type sub-pixel and the fourth type sub-pixel, and
the light of the third color, which is emitted from the third light source in a third field of the frame, passes through the second type sub-pixel, the third type sub-pixel and the fourth type sub-pixel.

17. The field sequential display apparatus of claim 16, wherein
a color coordinate point of a color displayed by light passed through the third type sub-pixel after being emitted from the second light source in the second field, and a color coordinate point of a color displayed by light passed through the second type sub-pixel after being emitted from the third light source in the third field are positioned outside a color coordinate triangle obtained by connecting a first color coordinate point of the first color of the light emitted from the first light source, a second color coordinate point of the second color of the light emitted from the second light source and a third color coordinate point of the third color of the light emitted from the third light source.

18. The field sequential display apparatus of claim 16, wherein
the first color is red,
the second color is green, and
the third color is blue.

19. A field sequential display method comprising:
allowing light of a first color, which is emitted from a first light source, to pass through a first type sub-pixel covered with a color filter of a second color, which is different from the first color, to display a third color, which is different from the first and second colors, in a first field of a plurality of fields of a frame,
wherein a color coordinate point of the third color is positioned outside a color coordinate triangle obtained by connecting color coordinate points of red, green and blue, which are displayed by the field sequential display method.

20. The field sequential display method of claim 19, further comprising:
allowing light of the second color, which is emitted from a second light source, to pass through a second type sub-pixel covered with a color filter of the first color to display a fourth color, which is different from the first and second colors, in a second field of the fields of the frame,
wherein a color coordinate point of the fourth color is positioned outside the color coordinate triangle.
